(19) United States
(12) Patent Application Publication
(10) Pub. No.: US 2002/0067356 A1
(43) Pub. Date: Jun. 6, 2002

(54) Three-dimensional image reproduction data generator, method thereof, and storage medium

(76) Inventors: Toshiyuki Sudo, Kanagawa (JP); Shinji Uchiyama, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/817,124

(22) Filed: Mar. 27, 2001

(30) Foreign Application Priority Data
Dec. 4, 2000 (JP) 2000-0368788

(51) Int. Cl. G06T 15/10; G06T 15/20

(52) U.S. Cl. 345/427

(57) ABSTRACT

Capturing the rays from emission points A, B, and C on plane P at each of viewing points a, b, c involves finding element images P (a), P (b), and P (c). If the ray entering the viewing point a from the emission point A is denoted as (A-a), the group of rays captured at the viewing point a will be (A-a), (B-a), and (C-a). Similarly, the group of rays (element image P (b)) captured at the viewing point b will be (A-b), (B-b), and (C-b) and the group of rays (element image P (c)) captured at the viewing point c will be (A-c), (B-c), and (C-c). Conversely, when finding an image on plane Q, if the viewing point is placed, for example, at point A, the group of rays that form the element image Q (A) will be (a-A), (b-A), and (c-A), which can be generated by using the first rays in the element images P (a), P (b), and P (c) described above.

### FIELD OF THE INVENTION

The present invention relates to a Three-dimensional image reproduction data generator, method thereof, and storage medium that generate Three-dimensional image reproduction data for a Three-dimensional image reproducer that directs a plurality of rays at the observer's one eye to form a Three-dimensional image at the intersection of the rays.

### BACKGROUND OF THE INVENTION

Conventionally, various systems have been tried out as methods for reproducing an image of a solid body. Above all, methods (polarizing glass method, lenticular method, etc.) are widely used that produce Three-dimensional vision by the use of binocular parallax. However, because of the discrepancy between the Three-dimensional perception produced through eye adjustments and Three-dimensional perception experienced through binocular parallax, there are not a few cases in which the observer feels tired or odd. Consequently, several Three-dimensional image reproduction methods have been tried that appeal to other functions of the eye for Three-dimensional perception instead of relying solely on binocular parallax.

“3D image reproduction by ray reproduction system” presented on pp.95-98 of collected papers of “3D Image Conference 2000” discloses a Three-dimensional display method for representing 3D images by using intersections of rays. As shown in FIG. 18, this system forms an intersection of rays using a ray generator, ray deflector, and sequence of ray emission points and represents a Three-dimensional(3D) image using a set of such intersections. The ray generator forms parallel light beams of very small diameter and the ray deflector causes the parallel light beams to cross each other at any given location in three-dimensional space to form a ray intersection. All the points at which rays are deflected are arranged at high density as a sequence of ray emission points. According to the above literature, if two or more rays forming an intersection enter the eye of the observer, the focus of the observer is placed near the 3D image, alleviating fatigue and uncomfortable feeling experienced by the observer.

However, the prior art has the following problems. With the three-dimensional display method that represents a 3D image by using intersections of rays as described above, the data of the 3D image takes an unconventional special form. Commonly used conventional Three-dimensional display methods employing binocular parallax, in particular, can represent a 3D image if parallax images from two or more views are provided. However, the system described above is totally incompatible with such parallax image data. To generate a 3D image specifically for the above system, it is necessary to determine the intersections of rays based on all the three-dimensional coordinate values on the surfaces of the 3D image. Consequently, the 3D images that can be reproduced are limited to three-dimensional computer graphics (3DCG), models whose three-dimensional geometries have been entered in a computer, and the like. To provide practicability and versatility, it is desired that the 3D display method that represents a 3D image by using intersections of rays can also handle general parallax images and photographic image data.

The present invention has been made in view of the above problems and its object is to generate data for reproduction of a 3D image using a plurality of parallax images.

### SUMMARY OF THE INVENTION

To achieve the purpose of the present invention, the 3D image reproduction data generator of the present invention has, for example, the following configuration.

Specifically, the present invention is a 3D image reproduction data generator that generates 3D image reproduction data for a 3D image reproducer that directs a plurality of rays at the observer's one eye to form a 3D image at the intersections of the rays. It generates 3D image reproduction data for reproduction of the 3D image using a plurality of parallax images.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a drawing showing the relationship between rays and the (3D) image reproduced from the rays;

FIG. 2 is a drawing illustrating image array Q (i, j);

FIG. 3 is a drawing illustrating image array P (x, y);

FIG. 4 is a drawing illustrating image array P (x, y);

FIG. 5 is a drawing illustrating how to shoot object 2;

FIG. 6 is a drawing illustrating how to shoot object 2;

FIG. 7 is a drawing illustrating a case in which object 2 is shot with the surface of a virtual screen inclined with respect to plane P;

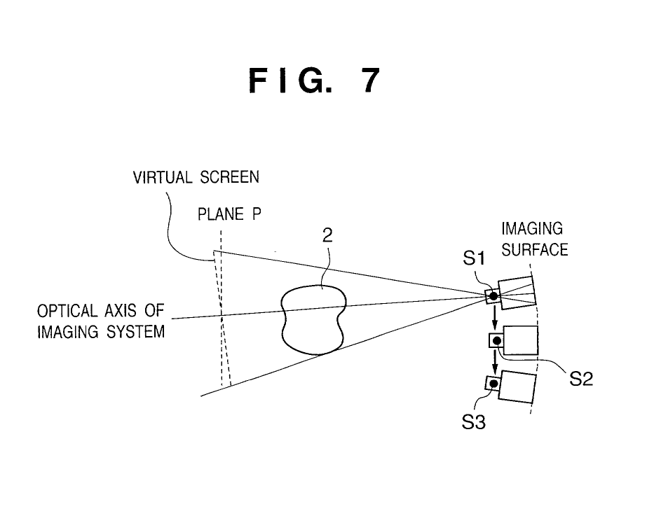

FIG. 8 is a drawing illustrating image array Q (i, j);

FIG. 9 is a drawing illustrating image array P (x, y);

FIG. 10 is a drawing illustrating how to determine image arrays Q (i, j) from image arrays P (x, y);

FIG. 11 is a drawing illustrating a case in which an area board is used;

FIG. 12 is a drawing showing the sequence of processes for shooting object 2 and finding image arrays P (x, y) of object 2;

FIG. 13 is a drawing illustrating a concrete example application of 3D image reproduction data;

FIG. 14 is a plan view of an apparatus that reproduces 3D images, illustrating the principle of 3D image generation;

FIG. 15 is a drawing showing various parts of an apparatus for generating 3D image s of object 2;

FIG. 16 is a drawing illustrating an example application to IP according to a second embodiment of the present invention;

FIG. 17 is a drawing of a simple example illustrating how to determine image arrays Q (i, j) from image arrays P (x, y);

FIG. 18 is a drawing illustrating a 3D display method for representing a 3D picture using intersections of rays; and

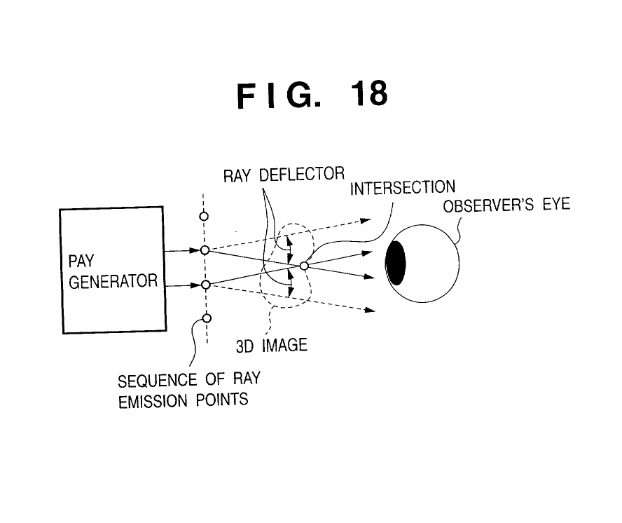

FIG. 19 is a block diagram showing the basic configuration of the 3D image reproduction data generator according to a first embodiment of the present invention.

### DETAILED DESCRIPTION OF THE PREFERRED EMBODIMENTS

Preferred embodiments of the present invention will now be described in detail in accordance with the accompanying drawings.

[First Embodiment]

The 3D image reproduction data generator and method thereof according to this embodiment is intended to solve the problem that the 3D display apparatus that represent the depth of a solid body by means of a plurality of rays incident on one eye of the observer must use an unconventional form of data. The 3D image reproduction data generator and method thereof according to this embodiment will be described below.

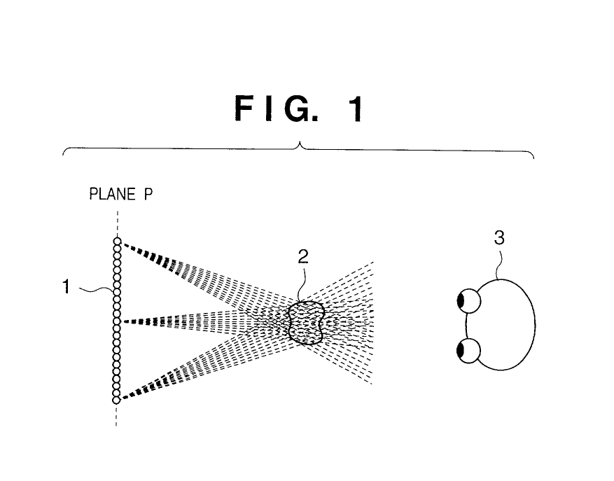

FIG. 1 shows the relationship between rays and the (3D) image reproduced from the rays. Ray emission points 1 are arranged at high density on plane P to form a sequence of ray emission points. The rays emitted from the ray emission points 1 intersects with each other. Since the spacing between individual rays are very narrow, the plurality of rays forming intersections enter the eye of an observer 3 simultaneously. Consequently, the observer 3 views them as a light flux and thus recognizes the ray intersection as a point image. A large collection of such ray intersections recognized as point images forms a 3D image 2.

To form any given 3D image 2, it is necessary to form ray intersections at any given locations in three-dimensional space. For that, it is necessary to control the directions and intensities of the rays emitted from the ray emission points 1 so that they can take any values.

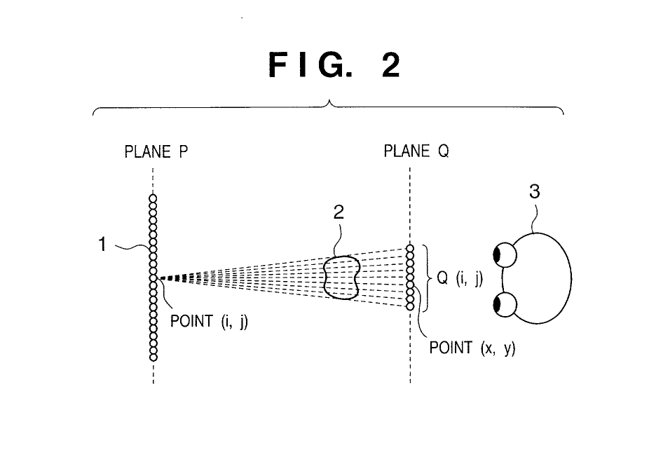

As procedures for controlling the direction and intensity of the rays for each ray emission point, it is useful to acquire such data as the intensity distribution of the rays, i.e., image data, on a sampling plane in advance. Specifically, as shown in FIG. 2, a ray sampling plane Q is placed near the 3D image 2 on a virtual basis and the light intensity distribution on plane Q is acquired as image arrays Q (i, j) corresponding to emission points (i, j). Information on the color and luminance of each pixel in the image array Q (i, j) corresponds one-to-one to ray information. There are as many arrays as the number of emission points.

However, the image array Q (i, j) described above is special data. As shown in FIG. 2, the image array Q (i, j) represents the 3D image 2 projected on plane Q by means of the point light source at the point (i, j) on plane P. This is a type of image completely different from the images we usually observe. (Although the position of our eyes during observation coincides with the focusing point of the rays in the cases of images we usually observe, the image in FIG. 2 is formed away from the focusing point of the rays.)

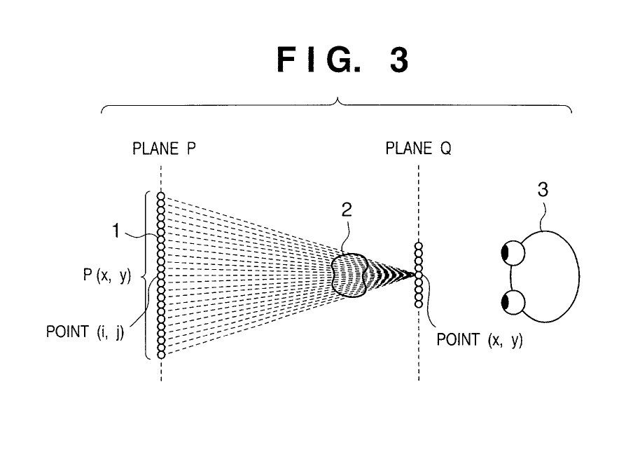

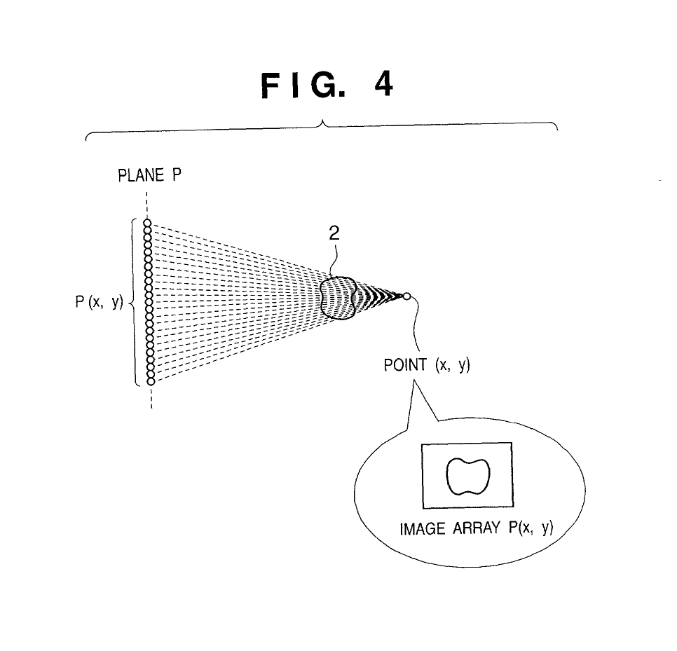

Therefore, the 3D image reproduction data generator and method thereof according to this embodiment first find typical image arrays P (x, y) (see FIG. 3) which are easier to create, and then determine the image arrays Q (i, j) from the image arrays P (x, y). FIG. 3 is an illustration of the image array P (x, y). The image array P (x, y) is the images obtained by sampling the rays that pass the point (x, y) on plane Q out of the rays that compose the 3D image 2, by using plane P as a sampling plane. There are as many image arrays P (x, y) as the number of points (x, y), where the number and alignment of the ray emission points (points (i, j) on plane Q) coincide with the pixel count and alignment of the individual images in the image array P (x, y). For example, the points (0, 0), (0, 1), (0, 2), (0, 3) on plane P correspond to image arrays P (0, 0), P (0, 1), P (0, 2), P (0, 3), respectively. As shown in FIG. 4, the image array P (x, y) is similar to the image obtained on the imaging surface when the point (x, y) is taken as the location of the viewing point in the imaging system.

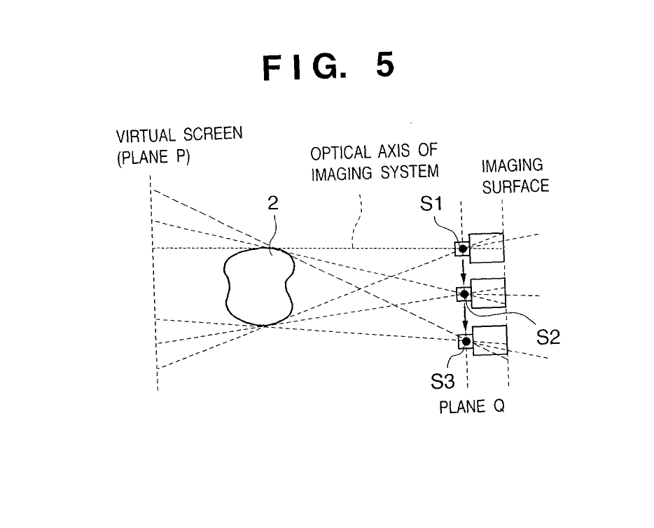

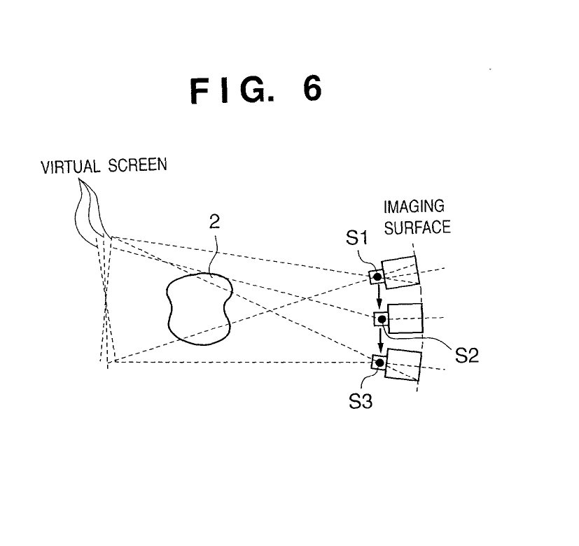

Here two imaging methods are available: the method (imaging method (A)) that involves moving the viewing point while keeping the optical axis of the imaging system perpendicular to the surface of a virtual screen as shown in FIG. 5 and the method (imaging method (B)) that involves moving the viewing point converging toward the object 2 as shown in FIG. 6. The imaging method (A) have the advantage that the virtual screen can be easily associated with plane P. However, even with the imaging method (B), it is possible to obtain image arrays P (x, y) on plane P by means of “keystone correction,” which is a typical computer image processing technique. Specifically, considering the inclination of the virtual screen with respect to plane P, the coordinates of the image on the virtual screen are transformed into the image coordinates on plane P.

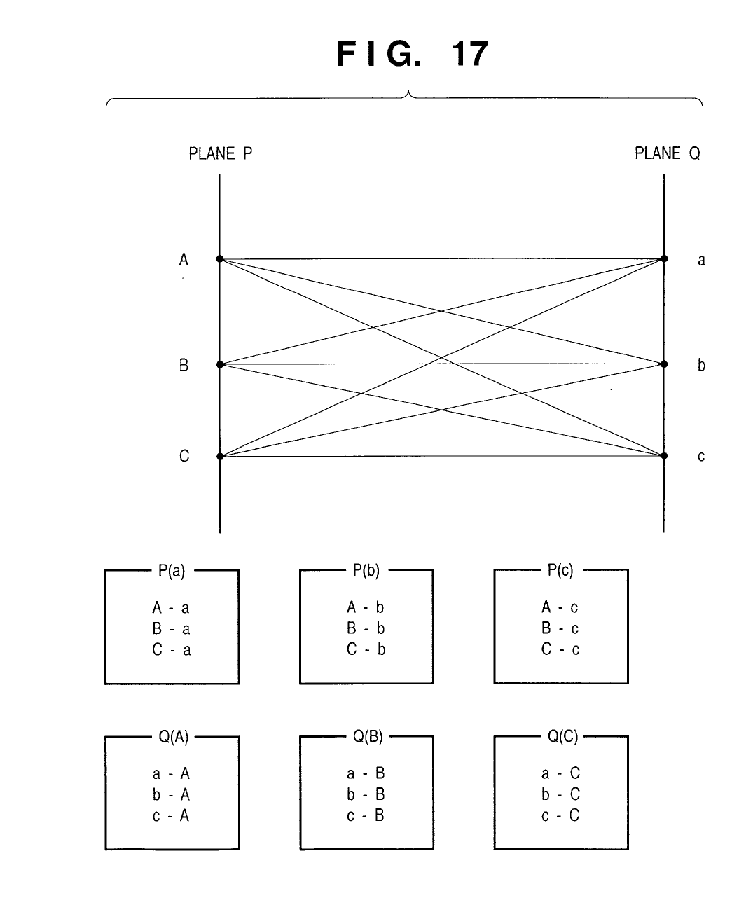

The following describes how to determine the image array Q (i, j) from the image array P (x, y). A simple example illustrating the method is shown in FIG. 17.

In the figure, three ray emission points A, B, and C are provided on plane P and three viewing points a, b, c are provided on plane Q. Now let's consider the case in which the rays from the emission points A, B, and C on plane P are captured at the viewing points a, b, c on plane Q. Capturing the rays at the viewing points a, b, c involves finding element images P (a), P (b), and P (c). If the ray entering the viewing point a from the emission point A is denoted as (A-a), the group of rays captured at the viewing point a will be (A-a), (B-a), and (C-a). Similarly, the group of rays (element image P (b)) captured at the viewing point b will be (A-b), (B-b), and (C-b) and the group of rays (element image P (c)) captured at the viewing point c will be (A-c), (B-c), and (C-c).

Conversely, when finding an image on plane Q, if the emission point is placed, for example, at point A, the group of rays that form the element image Q (A) will be (a-A), (b-A), and (c-A), which can be generated by using the first rays in the element images P (a), P (b), and P (c) described above. Similarly, if the emission point is placed, for example, at point B, the group of rays that form the element image Q (B) will be (a-B), (b-B), and (c-B), which can be generated by using the second rays in the element images P (a), P (b), and P (c) described above. The element image Q (C) can be generated in a similar manner. In short, the image array Q can be generated by arranging the pixels at the same location in each image of the image array P, obtained from a plurality of viewing points, in the order of the image alignment. In this way, element images on plane Q can be generated by using element images on plane P.

A general case of the above example will be described below. The following describes, in particular, how to determine the image array Q (i, j) from the image array P (x, y) as shown in FIGS. 2 and 3.

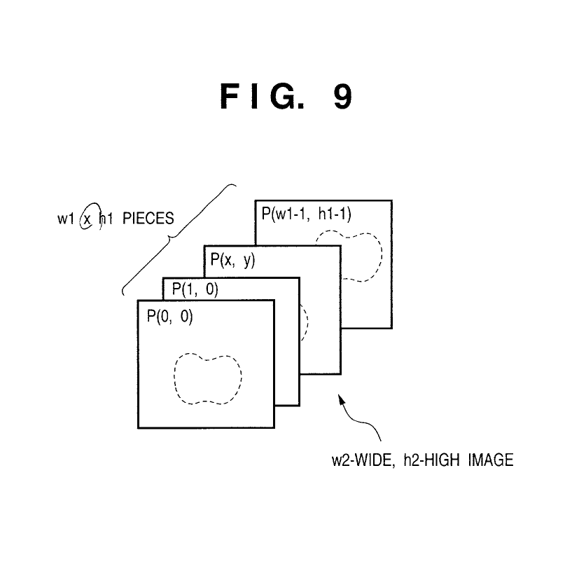

Referring to FIG. 3, since the individual pixels in the image array P (x, y) correspond one-to-one to the ray emission points on plane P, if it is assumed that there are w2 emission points in the horizontal direction and h2 emission points in the vertical direction, the image array P (x, y) consists of images w2 wide and h2 high. It is assumed further that viewing points (x, y) exist in a range with a resolution of w1 in the horizontal direction and h1 in the vertical direction and that x and y take integer values 0 to w1−1 and 0 to h1−1, respectively. Therefore, there should be w1×h1 image arrays P (x, y) in total as shown in FIG. 9.

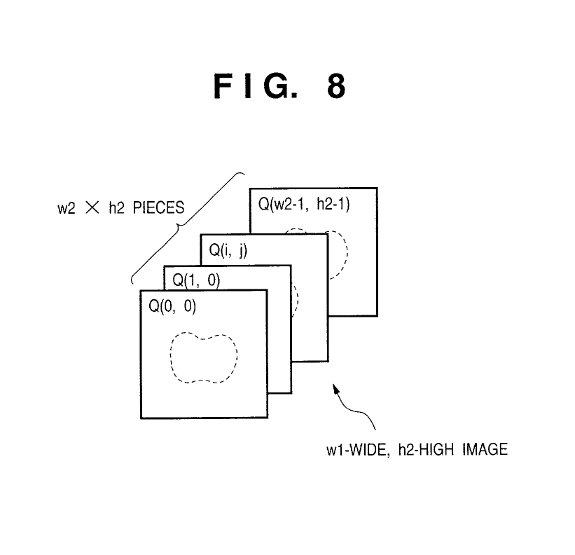

As described above, since there are w1 viewing points in the horizontal direction and h1 viewing points in the vertical direction, the image array Q (i, j) consists of images w1 wide and h1 high (see FIG. 2). Since ray emission points (i, j) exist in a range with a resolution of w2 in the horizontal direction and h2 in the vertical direction, i and j take integer values 0 to w2−1 and 0 to h2−1, respectively. Therefore, there should be w2×h2 image arrays Q (i, j) in total as shown in FIG. 8.

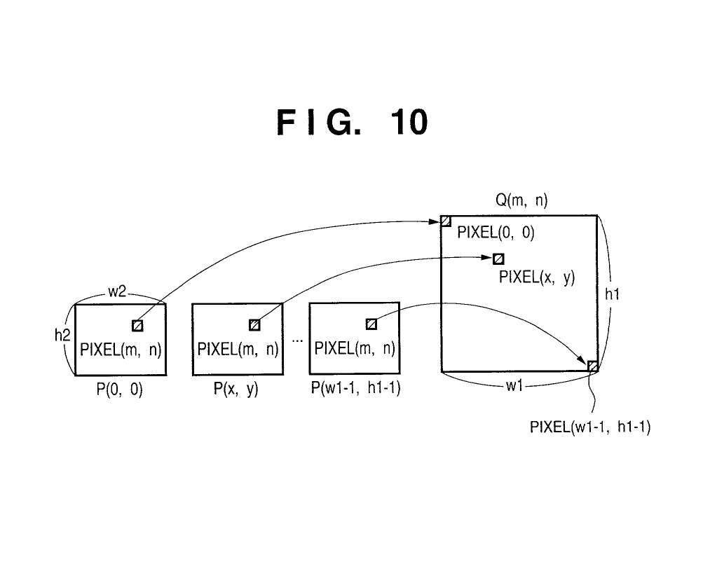

Since the image array Q is generated by arranging the pixels at the same location in each image of the image array P, obtained from a plurality of viewing points, in the order of the image alignment as described above with reference to the simple example in FIG. 17, the pixel information at the coordinates (m, n) from all the element images of the image arrays P (0, 0), P (x, y), . . . , P (w1−1, h1−1) are mapped to the pixel information at the coordinates (0, 0), (x, y), . . . , (w1−1, h1−1) in any given element image Q (m, n) of the image arrays Q (i, j) as described in FIG. 10. As a result, the given element image Q (m, n), which is a w1-wide, h1-high image, can be generated. If the image generating operation described above is performed for all the values of m and n by varying m and n (where m and n are integers in the same range as i and j), w2×h2 image arrays Q (i, j) can be obtained.

Thus, according to the method described above, arrays Q (i, j) of ray data for a 3D display apparatus that represents the depth of a solid body by means of a plurality of rays incident on one eye can be determined from arrays P (x, y) of typical parallax images.

Now description will be given about the image generation method for adjusting the dimensions of the parallax image array P (x, y) described above. As described above, when a 3D image is reproduced, the dimensions of the ray emission points must match the dimensions of the individual images in the image array P (x, y). Also, the dimensions of the individual images in the image array Q (i, j) must match the dimensions of the locations of the viewing points for obtaining the parallax image array P (x, y).

The method for correcting the dimensions of the parallax image array P (x, y) will be described first. The description assumes the use of the imaging method (A) described above. Needless to say, however, this correction method can also be applied to the parallax image array P (x, y) obtained by the imaging method (B) if image processing by keystone correction is incorporated into the process.

With the imaging method (A), the optical axis of the parallax imaging system moves perpendicular to the virtual screen as shown in FIG. 5. Therefore, the angle of view of the imaging system on the virtual screen is larger than the area of existence of the emission points, meaning that information outside the area of existence will also be acquired. Besides, since the optical axis moves together with the viewing point, there is a fear that the area of existence of the emission points may go out of the angle of view of the imaging system.

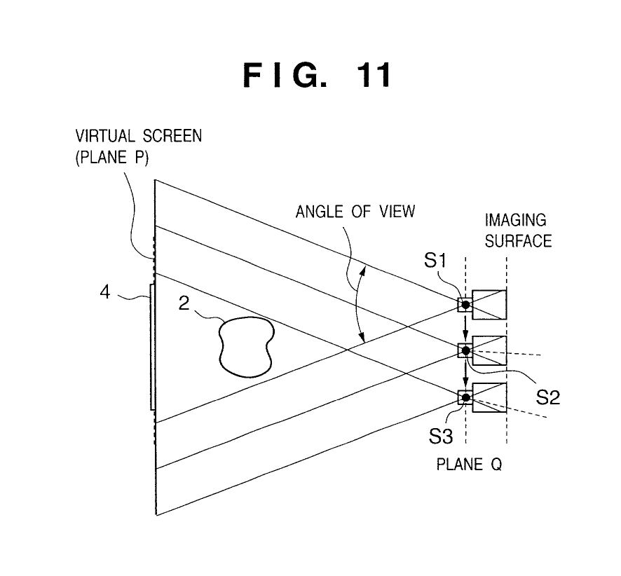

So, as shown in FIG. 11, an area board 4 with a size equivalent to the area of existence of the emission points is provided, the angle of view of the imaging system is adjusted such that the area board 4 falls within the angle of view from any viewing point, and the area board 4 is shot together with the object 2. Then by clipping the area that corresponds to the area board 4 out of the acquired image, only the image information in the area of existence of the emission points can be obtained.

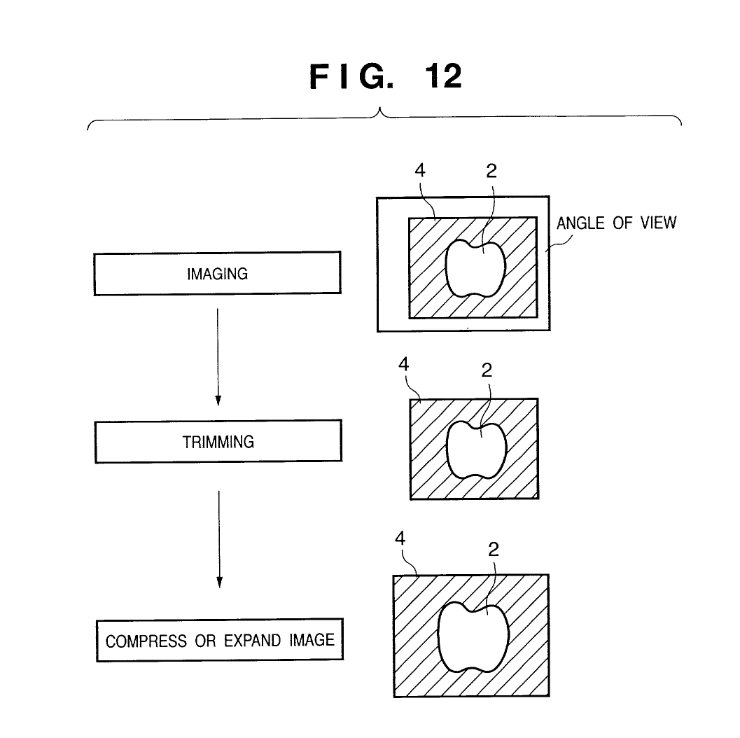

With this image generation method, however, the dimensions of the trimmed image do not always match those of the image array P (x, y). Therefore, the trimmed image is shrunk or stretched to match their dimensions to the dimensions of the image array P (x, y). Of course, pixels are interpolated as required. The sequence of the processes described above is summarized as shown in FIG. 12. The figure shows the sequence of processes required to shoot the object 2 and find the image array P (x, y) of the object 2.

Needless to say, the series of techniques described above can be used both to generate parallax images on a virtual basis on a computer and to obtain parallax images as photographs. In the former case, a virtual area board 4 is set up in a virtual space constructed on a computer and in the latter case, an actual area board 4 is constructed for use as a real background in imaging.

If the correspondence between the locations (viewing points) in the imaging system and trimming range in the acquired image is known in advance, it is not always necessary to set up an area board 4 and the image can be trimmed using the procedures as if a transparent virtual area board 4 existed.

On the other hand, the dimensions of the viewing points for obtaining the parallax image array P (x, y) must match the dimensions of the individual images in the image array Q (i, j), but since the image array Q (i, j) is nothing but information about the rays for reproducing a 3D image sampled on plane Q, the range that can be reached by rays from any emission point can be defined as the effective range of the locations of viewing points if the range of the rays that can reach plane Q is found in advance based on the deflection angle of rays and range of emission points. Although the dimensions of the locations of viewing points are determined based on the above-mentioned ranges and the spacing between the viewing points, it is desirable to adjust both ranges and dimensions taking into consideration the amount of information that can be handled and the desirable observation range of 3D images.

When using the imaging method (B), if the viewing points are moved with convergence such that the optical axis of the imaging system will pass the center of the area board 4 described above, the parallax image array P (x, y) with accurate dimensions can be obtained by image processing alone without any concern for the existence of the area board 4. In this case, since the locations of the viewing points move along a plane different from plane Q, appropriate coordinate transformation is used to obtain the image array Q (i, j) with accurate dimensions.

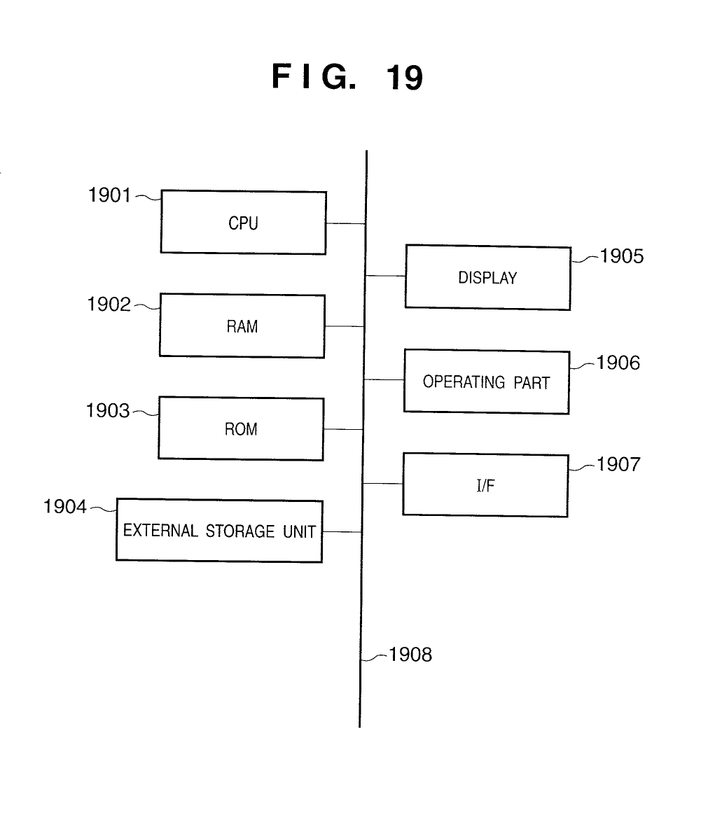

The 3D image reproduction data generator for generating 3D image reproduction data (image array Q (i, j)) according to this embodiment is shown in FIG. 19.

Reference numeral 1901 denotes a CPU, which reads program code and data out of memory such as a RAM 1902 or ROM 1903 and runs various processes.

Reference numeral 1902 denotes the RAM, which has an area for temporarily storing program code and data loaded from an external storage unit 1904 as well as a work area for the CPU 1901 to run various processes.

Reference numeral 1903 denotes the ROM, which stores control program code for the entire image reproduction data generator according to this embodiment.

Reference numeral 1904 denotes the external storage unit, which stores the program code and data installed from storage media such as CD-ROMs and floppy disks.

Reference numeral 1905 denotes a display, which consists of a CRT, liquid crystal screen, etc. and can display various system messages and images.

Reference numeral 1906 denotes an operating part, which consists of a keyboard and a pointing device such as a mouse and allows the user to enter various instructions.

Reference numeral 1907 denotes an interface (I/F), which connects to peripheral devices, networks, etc., allowing the user, for example, to download program code or data from a network.

Reference numeral 1908 denotes a bus for connecting the parts described above.

The operation of the parts described above makes it possible to determine the image array Q (i, j) from the image array P (x, y). Incidentally, although the 3D image reproduction data generator is a computer which has the above configuration in this embodiment, the present invention is not limited to this. It can also employ, for example, a specialized processing board or chip for determining the image array Q (i, j) from the image array P (x, y).

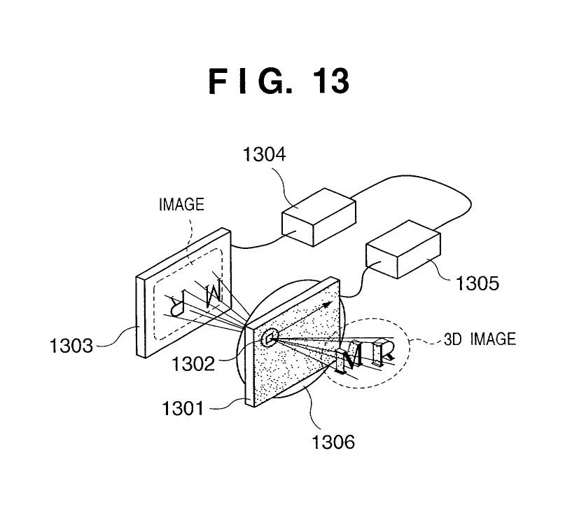

Now a concrete example application of the 3D image reproduction data will be described. FIG. 13 is a block diagram of the apparatus used for this example application.

Reference numeral 1301 denotes an aperture-forming panel, which forms a small aperture 1302 at any given location. This small aperture 1302 serves as an emission point. The small aperture 1302, which moves at high speed, looks like a sequence of multiple ray emission points in the eyes of the observer who views the rays emitted from it. The rays passing through the aperture-forming panel 1301 are deflected via a convex lens 1306.

An image display panel 1303 consists of a light source array that can form any light intensity distribution. The above-mentioned formation of the light intensity distribution and the formation of the small aperture 1302 are synchronized under the control of an image control device 1304 and aperture control device 1305. The angles of the rays emitted from the small aperture 1302 is determined by the locations of the light sources on the image display panel 1303. To change the angles of the rays emitted, the locations of the light sources on the image display panel 1303 can be varied. To control the angles of multiple rays simultaneously, the light intensity distribution formed on the image display panel 1303 by means of a plurality of light sources is varied according to the location of the small aperture 1302. It can be seen from the above description that all the three elements—namely, the “sequence of ray emission points,” “ray generator,” and “ray deflector”—necessary for the 3D display method for representing a 3D image by means of ray intersections are implemented in the above configuration.

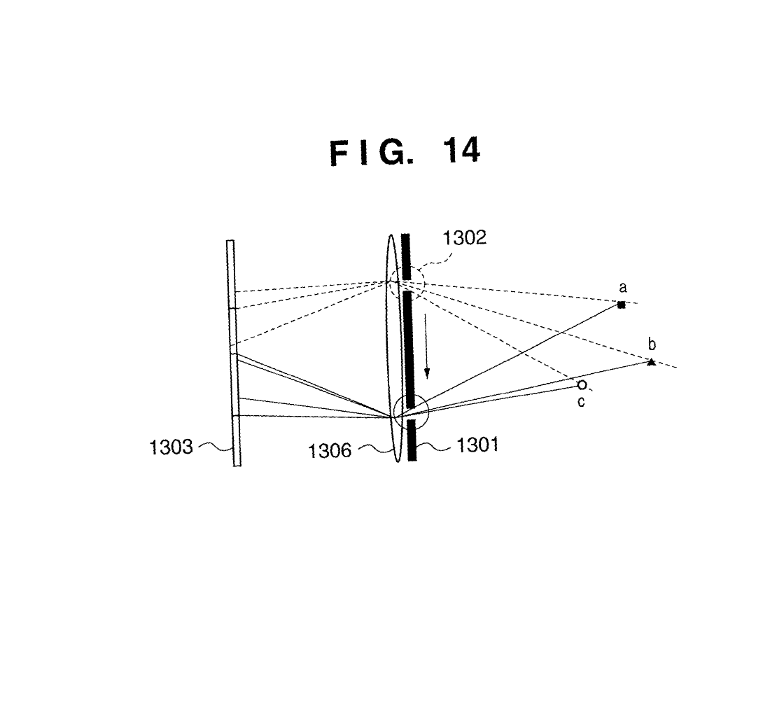

Now the principle of reproduction of a 3D image will be described with reference to FIG. 14, which is a plan view of the apparatus for generating 3D images. The same reference numerals as those of FIG. 13 show the same parts. FIG. 14 is a plan view of the apparatus at two different times. To reproduce points a, b, and c in three-dimensional space in this system, which represents a 3D image by means of ray intersections, rays from the small aperture 1302 must pass all the desired points a, b, and c at any time. Therefore, the light emission pattern on the image display panel 1303 changes constantly in accordance with the location of the small aperture 1302 so that the desired rays will be emitted from the small aperture 1302. Such actions repeated at high speed look like light fluxes emitted from the points a, b, and c in the eyes of the observer and are perceived as a 3D image. In the above apparatus, the image displayed on the image display panel 1303 is the image arrays Q described above.

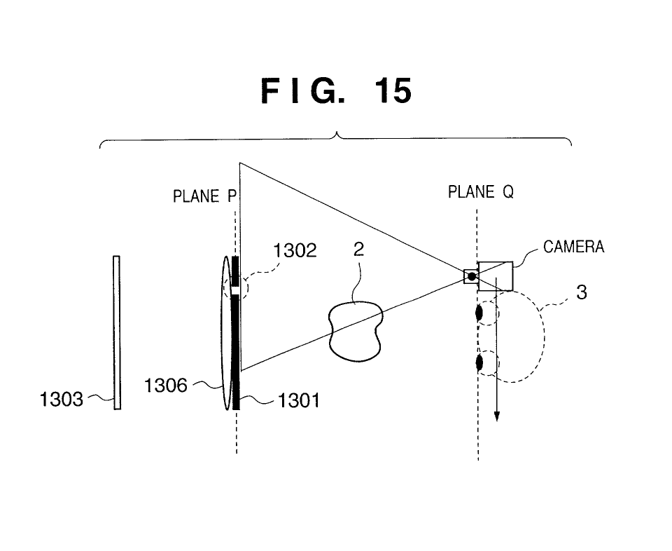

FIG. 15 shows the individual parts of the apparatus for generating three-dimensional images of the object 2. Plane P coincides with the surface of the aperture-forming panel 1301 and plane Q is located near the viewing position of the observer 3. The image arrays P (x, y) are obtained by shooting a virtual object or real object 2 with a virtual camera or real camera from a plurality of viewing points on plane Q. The dimensions of the parallax image arrays P (x, y) are matched to those of the existence sphere and number of the small apertures. For example, to reproduce a solid body by scanning 1-mm square small apertures at high speed in a 400 mm wide×300 mm high area of the aperture-forming panel 1301, there should exist 400 small apertures in the horizontal direction and 300 small apertures in the vertical direction. Thus, the dimensions of the parallax image arrays P (x, y) are defined as 400×300. The trimming of parallax images, etc. are carried out in the manner described above. When the parallax image arrays P (x, y) are obtained in this way, the image arrays Q (i, j) are found through the data conversion method described above and are used as the intensity distribution of the rays. Besides, the data obtained by converting the Q (i, j) distribution optically by means of the convex lens 1306 in the apparatus is used as the luminance distribution on the aperture-forming panel 1301.

Thus, the 3D image reproduction data generator and method thereof according to this embodiment can display an object as the 3D image using parallax images without finding three-dimensional coordinate values on the surfaces of the object.

[Second Embodiment]

This embodiment will be described in relation to integral photography (hereinafter abbreviated to IP), another example application of the 3D display of the object 2 shown in FIG. 15. IP is a method that involves recording an image of a three-dimensional object on a dry plate through an array of small lenses known as a fly's-eye lens, developing the image, and then illuminating it from behind to obtain a 3D image at the location of the original object. If the distance between individual lenses are sufficiently small, the IP system may also be considered as a type of 3D image reproducer that generates a 3D image using ray intersections, assuming that the individual lenses are equivalent to emission points and that the recorded image information is equivalent to a ray intensity distribution.

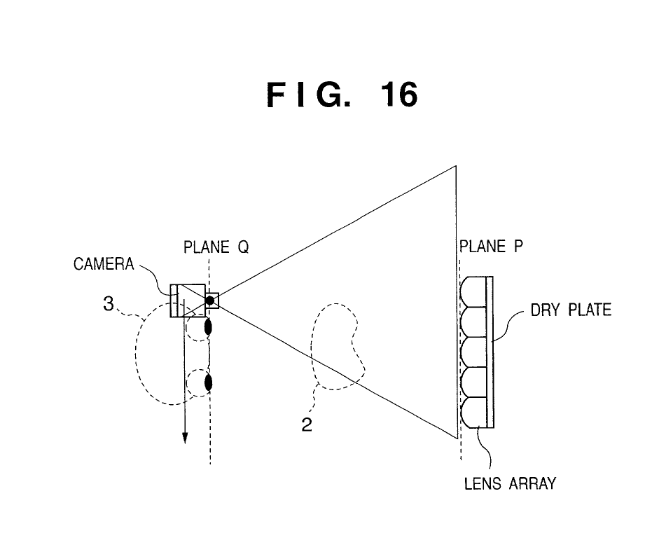

Therefore, it is possible to generate 3D image reproduction data for the IP system from parallax images using the method for generating image arrays Q from image arrays P, described in relation to the first embodiment, with plane P placed at the position of the lens array and plane Q placed near the viewing position of the observer 3 as shown in FIG. 16. The parallax image arrays P (x, y) are obtained by shooting a virtual object or real object 2 with a virtual camera or real camera from a plurality of viewing points on plane Q. The dimensions of the parallax image arrays P (x, y) are matched to those of the small-lens array. When the parallax image arrays P (x, y) are obtained in this way, the image arrays Q (i, j) are found through the data conversion method described above and are used as the intensity distribution of the rays, i.e., the images on the dry plate that correspond to individual small lenses.

As described above, the present invention can generate data for reproduction of 3D images using a plurality of parallax image.

As many apparently widely different embodiments of the present invention can be made without departing from the spirit and scope thereof, it is to be understood that the invention is not limited to the specific embodiments thereof except at defined in the claims.

What is claimed is:

1. A 3D image reproduction data generator that generates 3D image reproduction data for a 3D image reproducer that directs a plurality of rays at an observer's one eye to form a 3D image at intersections of the rays,
wherein said data generator generates 3D image reproduction data for reproduction of said 3D image using a plurality of parallax images.

2. The 3D image reproduction data generator according to claim 1, wherein said plurality of parallax images are images acquired at a plurality of viewing points, and their pixel count and alignment match the number and alignment of ray sources.

3. The 3D image reproduction data generator according to claim 2, wherein when obtaining said plurality of parallax images, only an effective area for generating said 3D image reproduction data is clipped by trimming.

4. The 3D image reproduction data generator according to claim 3, wherein after said trimming, the trimmed image is further shrunk or stretched.

5. The 3D image reproduction data generator according to claim 2, wherein when obtaining said plurality of parallax images, to limit an effective area for generating 3D image reproduction data, an area indicator board that indicates said area is shot together with the object.

6. The 3D image reproduction data generator according to claim 5, wherein said area indicator board is set up virtually and is not taken into the parallax image data acquired.

7. The 3D image reproduction data generator according to claim 2, wherein when obtaining said plurality of parallax images, the locations of the viewing points move in the imaging system such that the optical axis of the imaging system will move in parallel.

8. The 3D image reproduction data generator according to claim 5, wherein when obtaining said plurality of parallax images, the locations of the viewing points move in the imaging system such that the optical axis of the imaging system will always pass through the center of said effective area.

9. The 3D image reproduction data generator according to claim 1, wherein said 3D image reproduction data is a group of rays emitted from the ray sources and sampled on a plane that is located near the observer and intersects with the group of rays, said data having pixel count and alignment that match the number of viewing points and alignment of said ray sources needed to obtain said parallax images.

10. The 3D image reproduction data generator according to claim 9, wherein said 3D image reproduction data is generated from said plurality of parallax images, with pixels from the same location in each of the parallax images arranged according to the alignment of the parallax images.

11. The 3D image reproduction data generator according to claim 1, wherein said 3D image reproduction data is represented as parallax image arrays Q (i, j) of w2 pixels wide×h2 pixels high parallax images, w2 and h2 coincide with the horizontal resolution and vertical resolution, respectively, of the viewing points for obtaining said parallax image data, and (i, j) corresponds to the locations of the ray sources capable of generating said 3D image reproduction data,
said parallax image data is represented as image arrays P (x, y) of w1 pixels wide×h1 pixels high images, w1 and h1 coincide with the horizontal resolution and vertical resolution, respectively, of said sources, and (x, y) corresponds to the locations of the viewing points for obtaining said parallax image, and
any given element image Q (m, n) of said image arrays Q (i, j) is formed by mapping the pixel information at the location (m, n) in said image arrays P (x, y) for all the values of x and y to the pixel information at the location (m, n) of the image Q (m, n).

12. A 3D image reproduction data generator that generates 3D image reproduction data for a 3D image reproducer that directs a plurality of rays at an observer's one eye to form a 3D image at intersections of the rays,
wherein said 3D image reproduction data generator generates said 3D image reproduction data for reproducing said 3D image by arranging pixels according to the alignment of said viewing points, said pixels being obtained from the same location in each of the parallax images acquired at a plurality of viewing points.

13. A 3D image reproduction generating method that generates 3D image reproduction data for a 3D image reproducer that directs a plurality of rays at an observer's one eye to form a 3D image at intersections of the rays,
wherein said generating method generates 3D image reproduction data for reproduction of said 3D image using a plurality of parallax images.

14. The 3D image reproduction data generating method according to claim 13, wherein said plurality of parallax images are images acquired at a plurality of viewing points, and their pixel count and alignment match the number and alignment of ray sources.

15. The 3D image reproduction data generating method according to claim 14, wherein when obtaining said plurality of parallax images, only an effective area for generating said 3D image reproduction data is clipped by trimming.

16. The 3D image reproduction data generating method according to claim 15, wherein after said trimming, the trimmed image is further shrunk or stretched.

17. The 3D image reproduction data generating method according to claim 14, wherein when obtaining said plurality of parallax images, to limit an effective area for generating 3D image reproduction data, an area indicator board that indicates said area is shot together with the object.

18. The 3D image reproduction data generating method according to claim 17, wherein said area indicator board is set up virtually and is not taken into the parallax image data acquired.

19. The 3D image reproduction data generating method according to claim 14, wherein when obtaining said plurality of parallax images, the locations of the viewing points move in the imaging system such that the optical axis of the imaging system will move in parallel.

20. The 3D image reproduction data generating method according to claim 17, wherein when obtaining said plurality of parallax images, the locations of the viewing points move in the imaging system such that the optical axis of the imaging system will always pass through the center of said effective area.

21. The 3D image reproduction data generating method according to claim 13, wherein said 3D image reproduction data is a group of rays emitted from the ray sources and sampled on a plane that is located near the observer and intersects with the group of rays, said data having pixel count and alignment that match the number of viewing points and alignment of said ray sources needed to obtain said parallax images.

22. The 3D image reproduction data generating method according to claim 21, wherein said 3D image reproduction data is generated from said plurality of parallax images, with pixels from the same location in each of the parallax images arranged according to the alignment of the parallax images.

23. The 3D image reproduction data generating method according to claim 13, wherein said 3D image reproduction data is represented as parallax image arrays Q (i, j) of w2 pixels wide×h2 pixels high parallax images, w2 and h2 coincide with the horizontal resolution and vertical resolution, respectively, of the viewing points for obtaining said parallax image data, and (i, j) corresponds to the locations of the ray sources capable of generating said 3D image reproduction data;
said parallax image data is represented as image arrays P (x, y) of w1 pixels wide×h1 pixels high images, w1 and h1 coincide with the horizontal resolution and vertical resolution, respectively, of said sources, and (x, y) corresponds to the locations of the viewing points for obtaining said parallax image data; and
any given element image Q (m, n) of said image arrays Q (i, j) is formed by mapping the pixel information at the location (m, n) in said image arrays P (x, y) for all the values of x and y to the pixel information at the location (m, n) of the image Q (m, n).

24. A 3D image reproduction data generating method that generates 3D image reproduction data for a 3D image reproducer that directs a plurality of rays at an observer's one eye to form a 3D image at intersections of the rays,
wherein said 3D image reproduction data generating method generates said 3D image reproduction data for reproducing said 3D image by arranging pixels according to the alignment of said viewing points, said pixels being obtained from the same location in each of the parallax images acquired at a plurality of viewing points.

25. A computer-readable storage medium that stores program code created in accordance with the method recited in claim 13.
